(19) United States
(12) Patent Application Publication
(10) Pub. No.: US 2015/0205924 A1
(43) Pub. Date: Jul. 23, 2015

(54) COB UNDERPAYMENT DETECTION

(71) Applicant: Emily H. McMakin, Nashville, TN (US)

(72) Inventor: Emily H. McMakin, Nashville, TN (US)

(21) Appl. No.: 14/160,061

(22) Filed: Jan. 21, 2014

(51) Int. Cl. G06F 19/00

(52) U.S. Cl. CPC G06F 19/328

(57) ABSTRACT

A system for managing coordination of benefits (COB) matches a provider's paid Medicaid and Medicare claims against corresponding data warehouses (the HETS database or state Medicaid databases) to identify possible underpayments. The claims are matched using patient demographic data. If the system determines that a payment made by Medicare/Medicaid to the service provider is less than an amount allowable by another insurance carrier for the service provided, it can generate a payment request for the difference between the allowable amount and the payment. If the commercial carrier has not yet made any payment, the payment request is a request for the difference to be paid by the second payer. If the carrier has paid the allowable amount to Medicare/Medicaid, the payment request is a request for the difference to be paid by Medicare/Medicaid.

### BACKGROUND OF THE INVENTION

1. Field of the Invention

The present invention generally relates to billing and payment systems, and more particularly to a method of obtaining payment for services such as health care or medical services which are covered by a third party, e.g., an insurance carrier.

2. Description of the Related Art

Doctors, hospitals and other health care service providers constantly struggle with patients and insurance companies to see that they have been fairly and properly paid for their services. Insurance claims and reimbursements can get even more complicated when there are multiple insurance carriers which might cover a particular service for a patient. For example, in America many people are covered by a primary insurance carrier (i.e., commercial) and are also covered by a secondary carrier, possibly a government agency such as Medicare or Medicaid. Medicare is a federally administered system of health insurance available to persons aged 65 and over, and certain younger people with disabilities. Medicaid is a federal and state funded health care program for low-income Americans.

The amounts payable to a service provider, and from whom they are payable, depend upon arrangements not only between the service provider and patient, but also between the carrier and patient, and between the service provider and carrier. The patient will typically pay a portion of the cost of services to the service provider directly, as a co-pay or part of a deductible in the agreement between the patient and the service provider. The service provider may have contracts with carriers which set different amounts for a particular service. In order to ensure compliance with these various terms, methods and systems have been devised which provide for coordination of benefits (COB). For example, U.S. Pat. No. 7,904,305 discloses a method wherein a provider compares claim data processed by an insurance claim processor with the claim data originally submitted, generates comparison data indicating whether the original claim data has been processed in accordance with predetermined claim processing rules, and retransmits revised claim data as appropriate. To avoid the rejection of medical insurance claim data, the system compares a diagnostic code with associated procedure codes and compares the procedure codes with associated supply codes using predetermined processing rules to determine whether they are properly associated.

U.S. Pat. No. 8,321,243 illustrates a system for the coordination of benefits when a patient is associated with at least two payers which generates a primary claim request based upon the identified product and the patient, and generates a COB claim request for the second payer based on a received first adjudicated reply associated with the primary claim request. The system is particularly advantageous for dual or multiple coverage situations, where a healthcare provider must submit claims to each benefit provider separately and inform providers of amounts that have been paid by previous providers, since such individual claim submissions are otherwise time consuming for the healthcare provider and may be susceptible to inaccuracies as employees of the healthcare provider submit multiple claim requests.

U.S. Patent Application Publication No. 2005/0033604 relates to a claims settlement system using real-time interactions to submit a claim, receive a predetermined fee schedule based on a patient's relationship to a provider, and automatically authorize a transfer of funds with established guidelines. The system provides asynchronous, real-time distributed computing between insurers and providers.

U.S. Patent Application Publication No. 2007/0033070 describes an automated collection system which captures a service rendered by a provider, determines a relationship between a third party payer and the provider that defines a preliminary allowed amount to be collected by the provider, and determines a first portion of the preliminary allowed amount that is to be collected from the service recipient.

U.S. Patent Application Publication No. 2013/0110539 shows a system for processing healthcare claims and remittances which searches a database for previously received claims corresponding to a patient identifier to determine if any claims are associated with a third party payer and, based on the result of a duplicate claim edit or a third party liability edit, submits the received claim to a payer. This approach overcomes problems resulting from the manual processes and the lack of transparency between billing and adjudication systems. A clearinghouse portal provides communications between providers and payers, and accesses a data warehouse to validate correct coordination of benefits.

### SUMMARY OF THE INVENTION

The present invention is generally directed to a method of managing coordination of benefits for a service provided to a consumer by receiving claim data from a service provider wherein the claim data includes service data associated with the service provided to the consumer and first demographic data associated with the consumer, receiving benefits data from a data warehouse of a first payer wherein the benefits data includes second demographic data and payment information including a payment made by the first payer to the service provider for the service provided, correlating the first demographic data with the second demographic data to identify the payment made by the first payer to the service provider as a possible underpayment, determining that the payment is less than an amount allowable by a second payer for the service provided, by executing fourth instructions in the computer system, and generating a payment request for the difference between the allowable amount and the payment. The first payer may for example be Medicare, in which case the data warehouse may be the HIPAA Eligibility Transaction System database, or the first payer may for example be Medicaid, in which case the data warehouse may be a state Medicaid database. In one implementation the second payer has made no remittance for the service provided to the consumer and the payment request is a request for the difference to be paid by the second payer, and the payment request is further sent to the second payer. In an alternative implementation the second payer has paid the allowable amount to the first payer for the service provided to the consumer and the payment request is a request for the difference to be paid by the first payer, and the payment request is further sent to the first payer. The service provided may a health care service when the consumer is a patient.

The above as well as additional objectives, features, and advantages of the present invention will become apparent in the following detailed written description.

### BRIEF DESCRIPTION OF THE DRAWINGS

The present invention may be better understood, and its numerous objects, features, and advantages made apparent to those skilled in the art by referencing the accompanying drawings.

FIG. 1 is a block diagram showing various entities involved in an example of conventional processing for health care service benefits with dual coverage;

FIG. 2 is a block diagram of a computer system programmed to carry out coordination of benefits (COB) underpayment detection in accordance with one implementation of the present invention;

FIG. 3 is a chart depicting a global process for COB underpayment detection in accordance with one implementation of the present invention;

FIG. 4 is a chart illustrating the logical flow for identification of coordination of benefits as part of the global process of FIG. 3 in accordance with one implementation of the present invention; and

FIG. 5 is a chart illustrating the logical flow for a payment management system as part of the global process of FIG. 3 in accordance with one implementation of the present invention.

The use of the same reference symbols in different drawings indicates similar or identical items.

### DESCRIPTION OF THE PREFERRED EMBODIMENT(S)

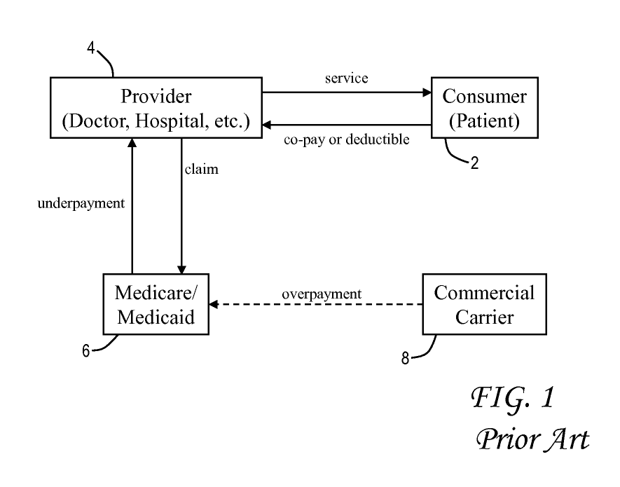

Government contractors, working for Medicaid and Medicare, are bypassing providers and recouping payments from commercial carriers that had primary coverage during the applicable date of service. See, e.g., the article “Overview of the Recovery Process: Group Health Plan,” Nov. 11, 2010 by Medicare Secondary Payer Recovery Contractor (downloaded from “http://www.msprc.info/processes/ghp flowchart.pdf”). Studies have indicated that Medicaid and Medicare pay a fraction of what a provider would receive for payment from a commercial carrier so, by not notifying the provider, the provider is losing revenue and the carrier is saving money. See the Congressional Budget Office report “Key issues in Analyzing Major Health Insurance Proposals,” December 2008, pp. XIX, 91-97 (downloaded from “http://www.cbo.gov/sites/default/files/cbofiles/ftpdocs/99xx/doc9924/12-18-keyissues.pdf”). The resulting underpayment is illustrated in FIG. 1. A patient 2 visits a doctor or other service provider 4 and receives health care services, for which she pays a portion in the form of a co-pay or deductible. Provider 4 then submits a claim to both Medicare or Medicaid (M/M) 6. The provider at this point is not billing the commercial carrier because the provider is unaware that COB exists. In this example, commercial carrier 8 pays nothing to provider 4, but M/M 6 pays an amount to provider 4 that is smaller than the amount allowed by the contract between provider 4 and carrier 8. This lower payment from M/M 6 to provider 4 is the underpayment of concern. The commercial carrier is only billed when the M/M contractor discovers COB and bills the commercial carrier itself. When the government contractor working for M/M makes the payment request to carrier 8, it is possible that carrier 8 will pay the full amount due under its contract with provider 4, i.e., an overpayment from the perspective of M/M. Not surprisingly, M/M is not eager to forward the overpaid amount back to provider 4, and so the provider may still end up underpaid.

In light of the foregoing, it would be desirable to devise an improved method of detecting such underpayments involved with coordination of benefits. It would be further advantageous if the method could get back any overpayment made to a secondary insurer such as M/M by a primary insurer. The present invention achieves these objectives by using the provider's data and M/M data to identify claims recovered by the contractors using data mining techniques. The M/M data may be acquired via the Medicaid databases created by each state or the HIPAA Eligibility Transaction System (HETS) database, or via other extraction techniques including COB files transmitted by M/M. The HETS database was introduced by the Centers for Medicare and Medicaid Services (CMS) to support real-time eligibility inquiries using standard transactions (HIPAA ANSI 270 eligibility request and ANSI 271 eligibility response). Once identified, the carriers are contacted for the additional fees owed to the provider for the services rendered. If the carrier has already paid the contracted fee in full then M/M is contacted so that overpaid fees are returned to the provider.

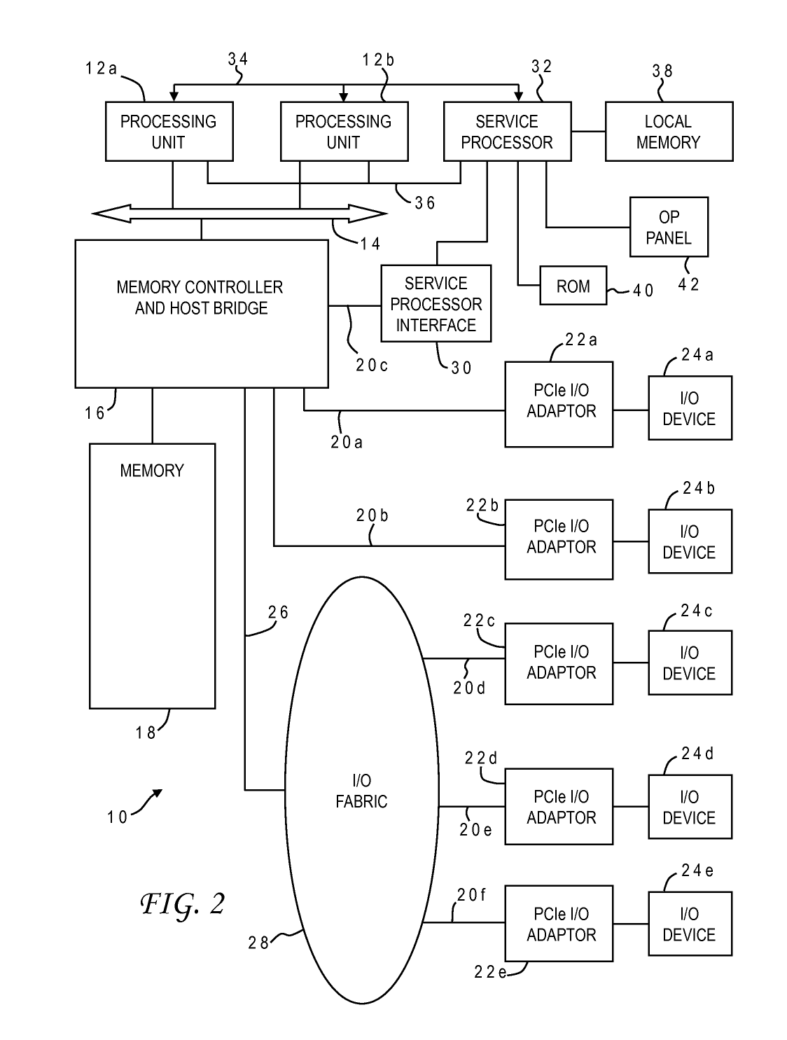

With further reference to FIG. 2, there is depicted one embodiment 10 of a computer system in which the present invention may be implemented to carry out detection of underpayments in coordination of benefits. Computer system 10 is a symmetric multiprocessor (SMP) system having a plurality of processors 12a, 12b connected to a system bus 14. System bus 14 is further connected to and communicates with a combined memory controller/host bridge (MC/HB) 16 which provides an interface to system memory 18. System memory 18 may be a local memory device or alternatively may include a plurality of distributed memory devices, preferably dynamic random-access memory (DRAM). There may be additional structures in the memory hierarchy which are not depicted, such as on-board (L1) and second-level (L2) or third-level (L3) caches.

MC/HB 16 also has an interface to peripheral component interconnect (PCI) Express links 20a, 20b, 20c. Each PCI Express (PCIe) link 20a, 20b is connected to a respective PCIe adaptor 22a, 22b, and each PCIe adaptor 22a, 22b is connected to a respective input/output (I/O) device 24a, 24b. MC/HB 16 may additionally have an interface to an I/O bus 26 which is connected to a switch (I/O fabric) 28. Switch 28 provides a fan-out for the I/O bus to a plurality of PCI links 20d, 20e, 20f. These PCI links are connected to more PCIe adaptors 22c, 22d, 22e which in turn support more I/O devices 24c, 24d, 24e. The I/O devices may include, without limitation, a keyboard, a graphical pointing device (mouse), a microphone, a display device, speakers, a permanent storage device (hard disk drive) or an array of such storage devices, an optical disk drive, and a network card. Each PCIe adaptor provides an interface between the PCI link and the respective I/O device. MC/HB 16 provides a low latency path through which processors 12a, 12b may access PCI devices mapped anywhere within bus memory or I/O address spaces. MC/HB 16 further provides a high bandwidth path to allow the PCI devices to access memory 18. Switch 28 may provide peer-to-peer communications between different endpoints and this data traffic does not need to be forwarded to MC/HB 16 if it does not involve cache-coherent memory transfers. Switch 28 is shown as a separate logical component but it could be integrated into MC/HB 16.

In this embodiment, PCI link 20c connects MC/HB 16 to a service processor interface 30 to allow communications between I/O device 24a and a service processor 32. Service processor 32 is connected to processors 12a, 12b via a JTAG interface 34, and uses an attention line 36 which interrupts the operation of processors 12a, 12b. Service processor 32 may have its own local memory 38, and is connected to read-only memory (ROM) 40 which stores various program instructions for system startup. Service processor 32 may also have access to a hardware operator panel 42 to provide system status and diagnostic information.

In alternative embodiments computer system 10 may include modifications of these hardware components or their interconnections, or additional components, so the depicted example should not be construed as implying any architectural limitations with respect to the present invention. The invention may further be implemented in an equivalent cloud computing network.

When computer system 10 is initially powered up, service processor 32 uses JTAG interface 34 to interrogate the system (host) processors 12a, 12b and MC/HB 16. After completing the interrogation, service processor 32 acquires an inventory and topology for computer system 10. Service processor 32 then executes various tests such as built-in-self-tests (BISTs), basic assurance tests (BATs), and memory tests on the components of computer system 10. Any error information for failures detected during the testing is reported by service processor 32 to operator panel 42. If a valid configuration of system resources is still possible after taking out any components found to be faulty during the testing then computer system 10 is allowed to proceed. Executable code is loaded into memory 18 and service processor 32 releases host processors 12a, 12b for execution of the program code, e.g., an operating system (OS) which is used to launch applications and in particular the COB underpayment detection program of the present invention, results of which may be stored in a hard disk drive of the system (an I/O device 24). While host processors 12a, 12b are executing program code, service processor 32 may enter a mode of monitoring and reporting any operating parameters or errors, such as the cooling fan speed and operation, thermal sensors, power supply regulators, and recoverable and non-recoverable errors reported by any of processors 12a, 12b, memory 18, and MC/HB 16. Service processor 32 may take further action based on the type of errors or defined thresholds.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable media may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. The computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this invention, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, written for a variety of platforms such as an AIX environment or operating systems such as Windows 7 or Linux. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. Such computer-readable storage media excludes transitory media such as propagating signals.

The computer program instructions may further be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Computer system 10 carries out program instructions for a recoupment process that uses novel data mining techniques to manage coordination of benefits. Accordingly, a program embodying the invention may additionally include conventional aspects of various COB tools, and these details will become apparent to those skilled in the art upon reference to this disclosure.

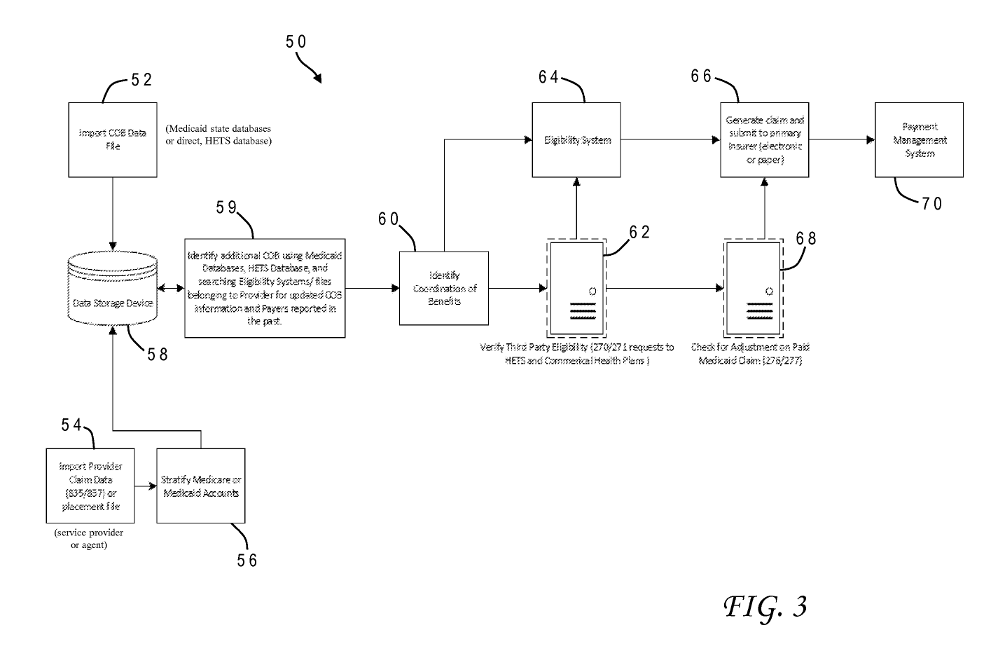

Referring now to FIG. 3, a global process 50 is shown for the detection of underpayments with COB in accordance with one implementation of the invention which may be carried out using computer system 10. Process 50 begins by importing data from various sources, including importing COB data 52 and importing provider claim data 54. The COB data may be imported from any data warehouse associated with claims requested from or paid by a first payer. The data warehouse may be administered by the first payer or by an agent. The term “data warehouse” as used herein generally refers to a collection of computerized data, organized for reporting or analysis, and may include without limitation one or more databases or an extracted file provided from the data warehouse or its agent. The relevant data is not necessarily stored as intact claims or remittances but rather could be stored as objects or separate data elements that together comprise a claim or remittance. In the specific case where the first payer is Medicare/Medicaid, the data warehouses can be the HETS database and the state Medicaid databases, such as the TennCare Medicaid Management Information System used by Tennessee or the TexMedConnect database in Texas. The COB data may include for example the patient account number as a unique identifier, patient demographic data, and the financial class code or payer field to eliminate non-government payers or accounts with secondary payers. The COB data may be imported electronically via the Internet into computer system 10, or by means of other networks including local area networks or mobile computing networks.

The provider claim data may be imported electronically from the service provider or its agent into computer system 10, also by means of the Internet or other networks, using a standardized or custom interface. The term “provider” as used herein generally refers to any provider of products or services, such as health care services, and may include without limitation entities such as physicians, dentists, pharmacies, entities providing medical information to meet regulatory requirements, hospitals, clinics and other medical facilities or suppliers. The provider claim data may include for example service data associated with the service performed for the consumer and demographic data associated with the consumer. The service data may include a service code and date(s) the service was performed. The demographic data may include the patient's name, date of birth, and social security number, or other identifying information. The provider claim data may for example be delivered in the form of an 837 health care claim transaction, an 835 health care payment advice, or a placement file.

The 837 health care claim transaction is a file prepared by a service provider to submit health care claim billing information and encounter information to an insurer, either directly or via intermediary billers and claims clearinghouses. It can also be used to transmit health care claims and billing payment information between payers with different payment responsibilities where coordination of benefits is required or between payers and regulatory agencies to monitor the rendering, billing, and/or payment of health care services within a specific health care/insurance industry segment.

The 835 health care payment advice is a computer file generated by M/M and sent to the provider that provides information for the payee (provider) regarding claims in their final status may by way of an 837 transaction, including information about the payee, the payer, the payment amount, and payment identifying information. In this regard, the term “payer” as used herein can refer to any third-party entity that pays claims or administers an insurance product or benefit, or both. For example and without limitation, a payer may be an insurance company, carrier, health maintenance organization (HMO), preferred provider organization (PPO), government agency (Medicare, Medicaid, Civilian Health and Medical Program of the Uniformed Services (CHAMPUS), etc.) or an entity such as a third party administrator (TPA) or third party organization (TPO) that may be contracted by one of those groups. A particular 835 file may not necessarily correspond one-for-one with a specific 837 file. The 835 advice can indicate what charges were paid, reduced or denied, whether there was a deductible, co-insurance, co-pay, etc., any bundling or splitting of claims or line items, and how the payment was made, such as through a clearinghouse. The 835/837 files have specified formats, i.e., fields and delimiters, so are easily imported.

A placement file can be used for providers that have not developed a process of exporting out their 835/837 data (or, due to HIPPA, may want to limit the number and types of fields they submit). Such providers may instead submit their own extract (the placement file) that takes a combination of the fields that exists within the 835/837 data. This placement file may for example include the vital fields of patient account number, date of service, patient demographic information, amount paid, amount denied, patient responsibility, payer name, etc.

When importing the COB data, the detection system is looking for commercial payers so it does not eliminate any non-government payers. The COB data warehouse should include any instance where there is the possibility of a commercial payer. The detection system can search for only government payers when looking through the 835/837 data from the provider as it is looking for scenarios in which the provider was unaware that COB exists. The COB data could come from directly pinging the provider eligibility system (or an eligibility/member extract), provider claim data (looking for scenarios where claims for that particular member have been billed and paid by another carrier), the Medicaid databases/data, or the HETS database. For this reason the import process may be somewhat complicated as the types of fields and data being received will vary. In general, the detection system will extract out the fields already mentioned and also will include items like policy number and effective dates. Most likely there will not be a patient account number in the COB data as that is claim level specific. The financial class code can also help eliminate matches as it will indicate when a plan is Visual, Dental, Catastrophic, etc. For instance, pharmaceutical payments are to be matched with pharmaceutical coverage, and medical coverage is to be matched with plans that coordinate and pay for medical claims. These data warehouses may also include items like the import date and a field that indicates whether the information is valid after checking it against payer portals or through a manual validation if no payer portal exists so that bad data can be eliminated and excluded going forward.

Once the provider claim data has been imported into computer system 10, any M/M accounts can be stratified 56, i.e., identified for local data storage accessible by computer system 10, as these are the accounts the software will be examining for additional recovery opportunity. The stratified provider claim data and COB data can be stored in a data storage device 58 within computer system 10 or external to computer system 10. Additional COB data can be identified using Medicaid databases or the HETS database, and searching eligibility systems/files belonging to a provider for updated COB information and payers reported in the past 59. The benefits data can then be correlated with the service data and demographic data by computer system 10 to identify coordination of benefits for any payment made by the first payer to the service provider for the service performed 60. The benefits data is correlated with the service data and demographic data by finding corresponding fields whose data matches. Patients with claims where the primary payer is Medicaid are queried against the state's Medicaid Eligibility System. Patients with claims where the primary payer is Medicare are queried against the HETS system.

Computer system 10 can follow up any claim from the provider claim data found to have a match with the COB data to ensure that proper payment has been made to the service provider. Third-party eligibility can be verified electronically via 270/271 requests to HETS or the commercial health plans 62. The electronic requests for commercial payers are generally referred to as patient portals. Any response can also be fed back to the COB data warehouse and indicate whether the COB information received was valid to avoid unnecessary queries in the future. The HETS 270/271 application allows providers or clearinghouses to submit HIPAA compliant 270 eligibility request files, and receive and deconstruct 271 eligibility response files in a real-time environment, to determine coverage eligibility. The verification response is considered by an eligibility system 64 to confirm that the claim is still eligible for reimbursement by a second payer. Concurrently with the eligibility determination, computer system 10 can check for any adjustment to the claim such as a Medicaid payment 66. This check can be performed by electronically submitting a 276 health care claim status inquiry to inquire about the status of a claim after it has been sent to a payer, and examining a resulting 277 health care claim status response.

If the eligibility of the claim has been verified, and the payment by the first payer is less than an amount allowable by the second payer for the service performed, computer system 10 can generate a payment request for the difference between the allowable amount and the payment 68, that is, the difference between the contracted rate of the commercial payer and the amount paid by M/M. Applicable state and federal guidelines are preferably followed during this recovery process. The payment request may be electronic or paper. This step of the process may optionally be validated manually by a claims analyst who reviews the eligibility and payment information. The payment request is then forwarded to a payment management system 70, which may also be running on computer system 10. Payment management system 70 can handle the details of submitting the payment request to the second (commercial) payer and monitoring the status of any further payments. If the commercial payer paid the provider's contracted rate to the government contractor, the payment request is a refund request sent to the contractor, requesting that the overpaid funds be sent to the provider so the commercial payer's outstanding balance can be resolved. Payment management system 70 can also send a status update to the provider's system so claims are processed correctly going forward.

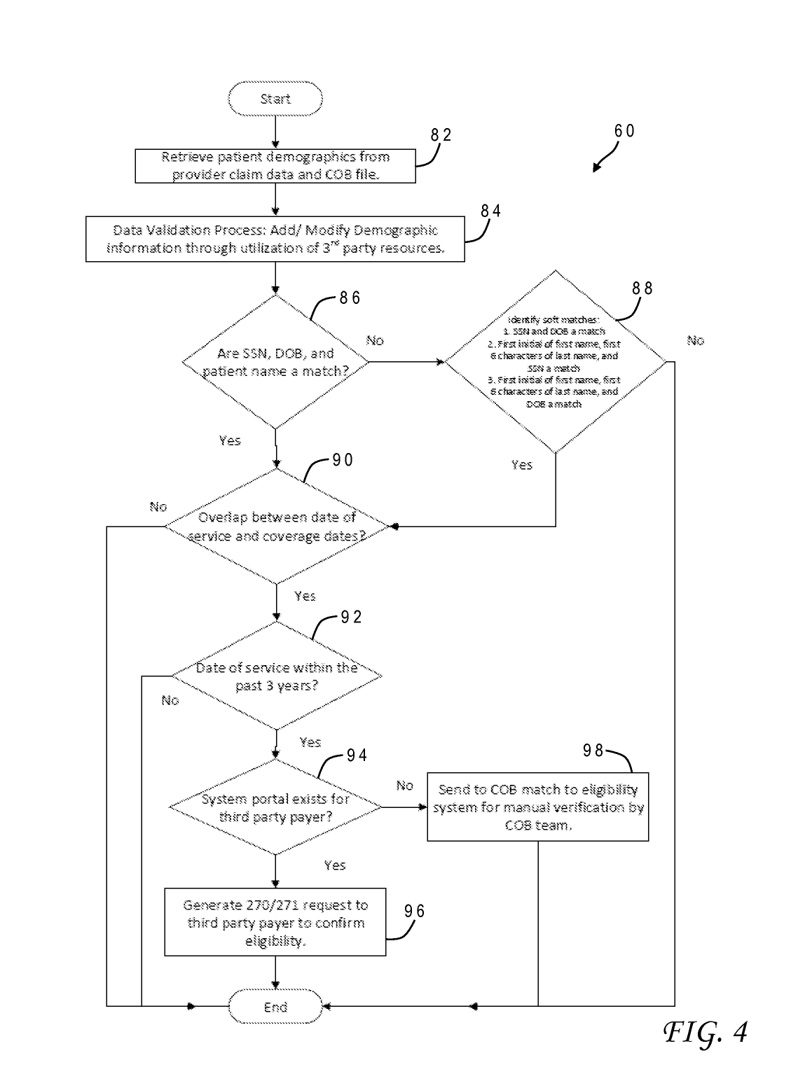

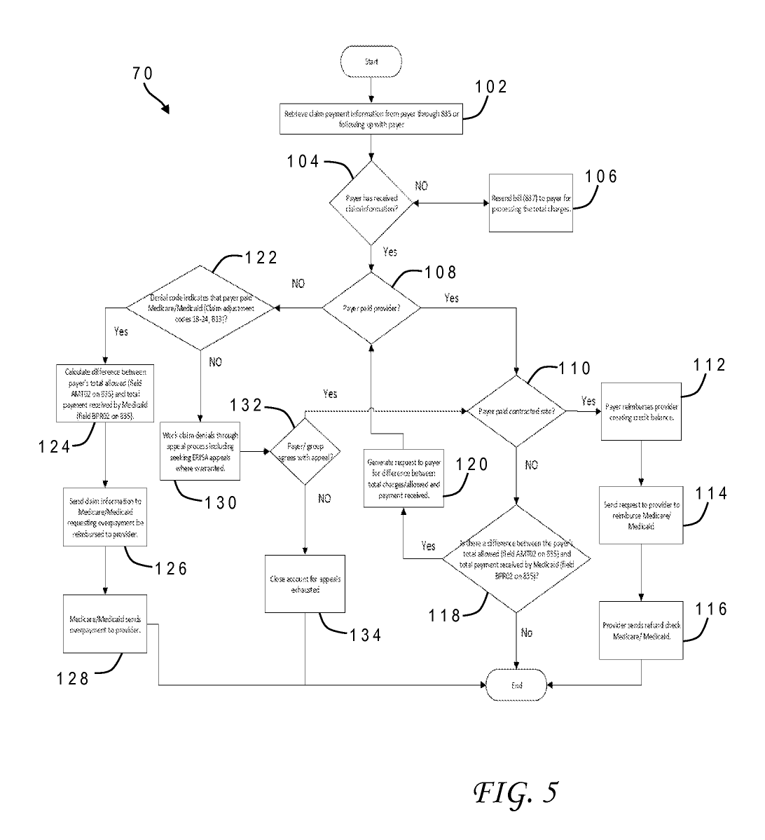

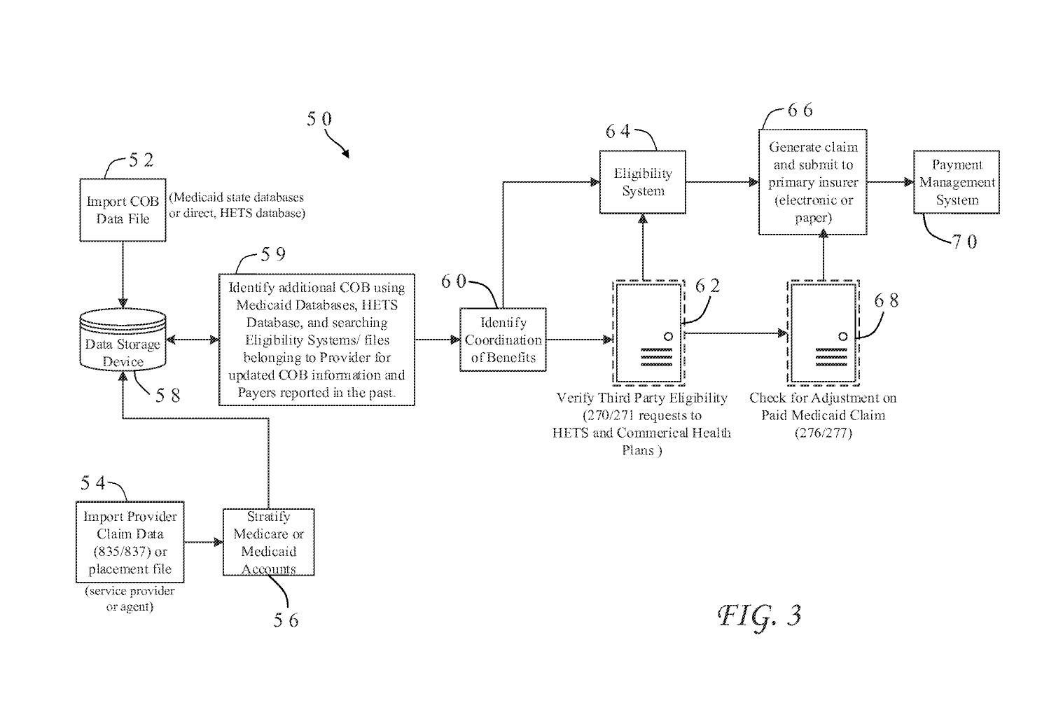

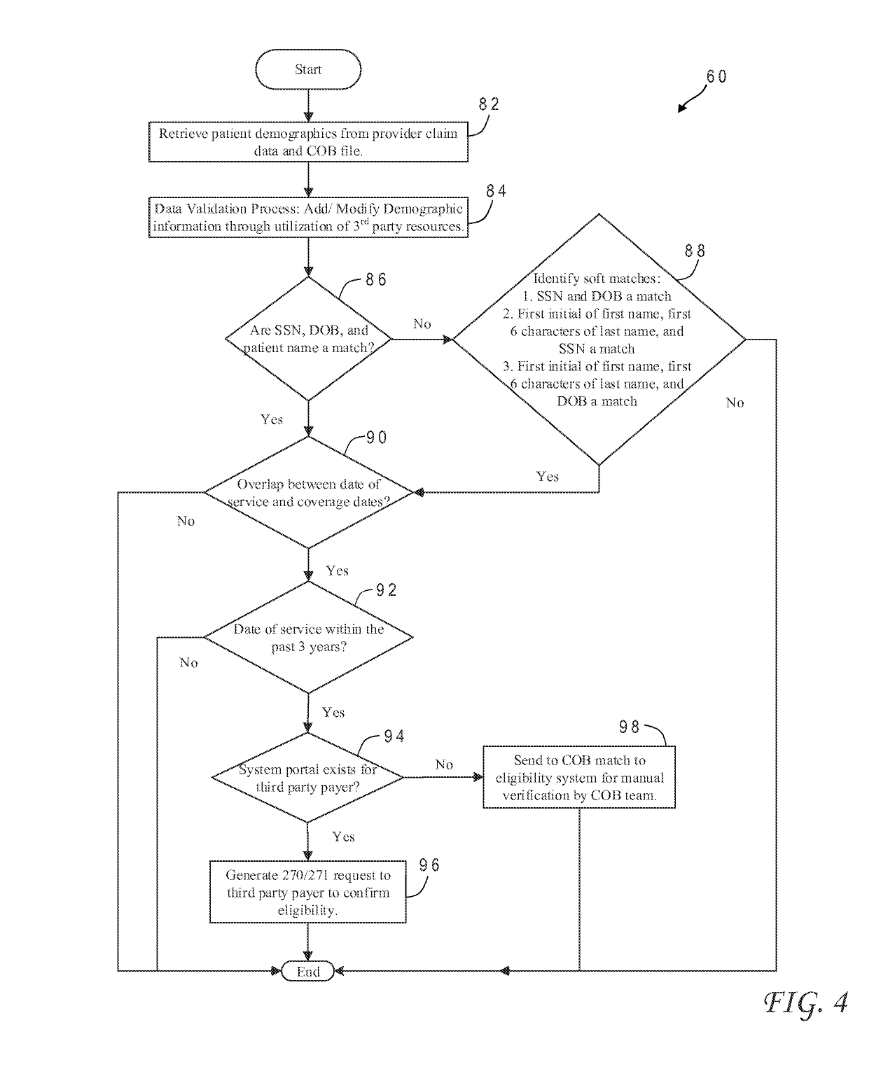

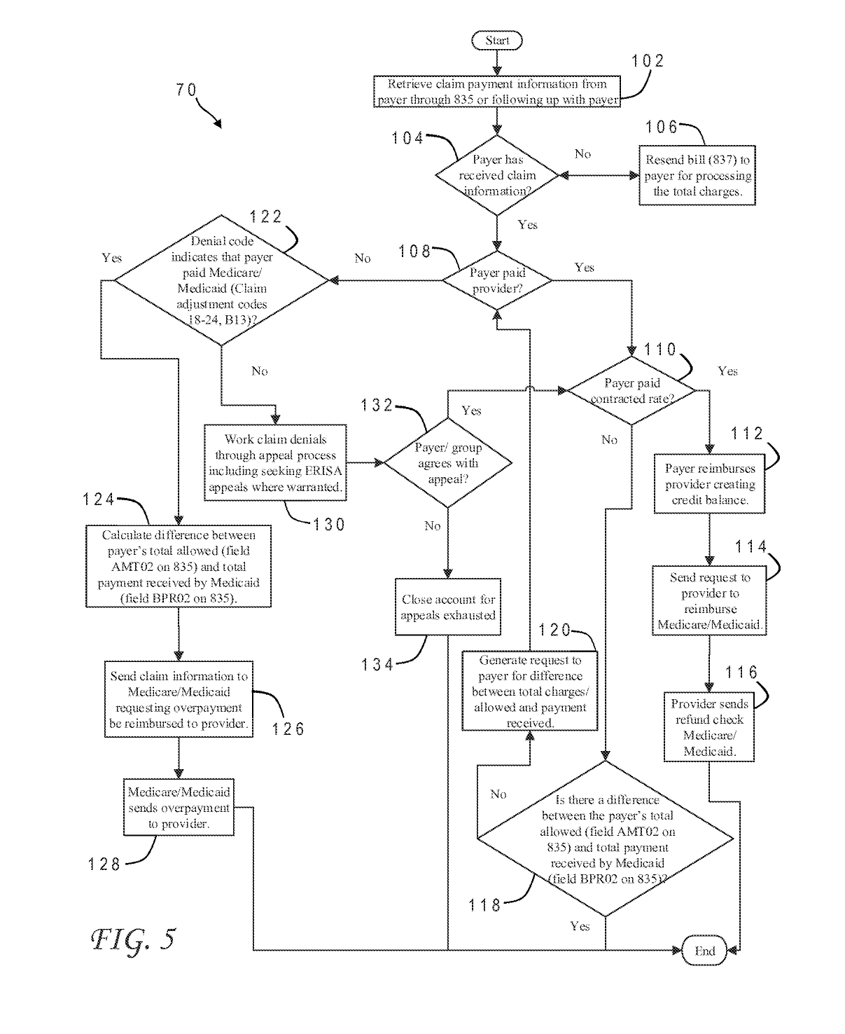

More specific details for the global process of FIG. 3 are seen in FIGS. 4 and 5. FIG. 4 shows details associated with the identification of coordination of benefits 60. This identification process begins by retrieving patient demographics from the provider claim data and COB file 82. The data validation process can include adding or modifying demographic information through the utilization of third-party resources 84, e.g., to fill in a missing middle name or social security number. If the social security numbers, dates of birth, and patient names from the two sources are the same, a match is indicated 86. Even if there is not an exact match, a “soft” (partial) match may still be identified 88. For example, a soft match may be declared for any of (i) a match between the social security numbers and dates of birth, (ii) a match between the social security numbers, the first initial of the first name, and the first six characters of the last name, or (iii) a match between the dates of birth, the first initial of the first name, and the first six characters of the last name. If there is no exact or soft match, the process ends for this iteration of retrieved claim data. If there is a match, the date of the service is checked against coverage dates for the second payer 90. If the date of service was not within the coverage period, or the date of service was not within the past three years 92, then the process again ends (the Deficit Reduction Act passed in 2005 required that states pass laws or regulations to compel carriers to make payments on claims submitted by the state within three years from the discharge date). Otherwise computer system 10 continues by determining whether the payer is on a list of payers having a system portal 94. If no system portal exists, the claim is sent to a COB match to eligibility system for manual verification by the COB team 98 and the process ends. If there is a system portal, computer system 10 can generate the 270/271 request to the payer to confirm eligibility.

FIG. 5 shows details for the process associated with payment management system 70. The payment management process begins by retrieving claim payment information from the commercial payer through an 835 health care payment advice or otherwise following up with the payer. If the payer has not received claim information 104, the bill (837) is resent to the payer for processing the total charges 106. If the payer has received the claim information, computer system checks the advice to see if the payer has paid the provider 108. If so, a further check is performed to see if the amount paid by the payer was at the full applicable commercial rate 110. If the payer paid the full rate, i.e., including the amount that was already paid by M/M, the payer reimburses the provider, creating a credit balance at the provider 112. Computer system 10 can then send a request to the provider to reimburse M/M 114, and the provider sends a refund check to M/M 116, ending the process. Returning to box 108, if the payer did not pay the provider, the denial code from the payer obtained from the 837 advice is check to see whether the payer paid M/M 122 (claim adjustment codes 18-24, B13). If the payer did pay M/M, computer system 10 calculates the difference between the commercial payer's total allowed (field AMT02 on the 835 transaction) and the total payment received by M/M (field BPR02 on the 835 transaction). Computer system 10 then sends the claim information to M/M requesting that the overpayment be reimbursed to the provider 126, and M/M sends the commercial overpayment to the provider 128, ending the process. Returning to box 122, if the denial code does not indicate payment to M/M, the claim denials can be worked in a conventional manner through the appeal process including seek Employee Retirement Income Security Act (ERISA) appeals where warranted 130. If the payer or group does not agree with the appeal, the account is closed, ending the process. Otherwise, the process continues at box 110.

It can be appreciated that the present invention thereby provides an efficient mechanism for the providers to eliminate accounts where the outstanding balance is equal to the total charges and, on the government warehouse side, to verify that their paid amount to date is less than the outstanding amount on the providers records. These advantages are not available in conventional post-pay data mining schemes which only match paid claims across commercial insurance carriers, or simply scrubs the data to narrow down the possibilities of COB. The present invention further does not require the provider to already be aware of coordination of benefits (which mainly relies on the patient's self-reporting) and indicate it somewhere on the claim submission (or expect the commercial carrier to be aware of other coverage, again through patient self-reporting), as is required by conventional approaches such as that seen in U.S. Patent Application no. 2013/0110539. The invention also does not require any clearinghouse.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. For example, while the invention has been described in the context of heath care services, it is not limited to only health care service providers but rather can be applied to any service where claims data might be warehoused. It is therefore contemplated that such modifications can be made without departing from the spirit or scope of the present invention as defined in the appended claims.

What is claimed is:

1. A method of managing coordination of benefits for a service provided to a consumer comprising:
receiving claim data from a service provider wherein the claim data includes service data associated with the service provided to the consumer and first demographic data associated with the consumer, by executing first instructions in a computer system;
receiving benefits data from a data warehouse of a first payer wherein the benefits data includes second demographic data and payment information including a payment made by the first payer to the service provider for the service provided, by executing second instructions in the computer system;
correlating the first demographic data with the second demographic data to identify the payment made by the first payer to the service provider as a possible underpayment, by executing third instructions in the computer system;
determining that the payment is less than an amount allowable by a second payer for the service provided, by executing fourth instructions in the computer system; and
generating a payment request for the difference between the allowable amount and the payment, by executing fifth instructions in the computer system.

2. The method of claim 1 wherein the first payer is Medicare, and the data warehouse is a HIPAA Eligibility Transaction System database.

3. The method of claim 1 wherein the first payer is Medicaid, and the data warehouse is a state Medicaid database.

4. The method of claim 1 wherein the second payer has made no remittance for the service provided to the consumer and the payment request is a request for the difference to be paid by the second payer, and further comprising sending the payment request to the second payer.

5. The method of claim 1 wherein the second payer has paid the allowable amount to the first payer for the service provided to the consumer and the payment request is a request for the difference to be paid by the first payer, and further comprising sending the payment request to the first payer.

6. The method of claim 1 wherein the service provided is a health care service and the consumer is a patient.

7. A computer system comprising:
one or more processors which process program instructions;
a memory device connected to said one or more processors; and
program instructions residing in said memory device for managing coordination of benefits for a service provided to a consumer by receiving claim data from a service provider wherein the claim data includes service data associated with the service provided to the consumer and first demographic data associated with the consumer, receiving benefits data from a data warehouse of a first payer wherein the benefits data includes second demographic data and payment information including a payment made by the first payer to the service provider for the service provided, correlating the first demographic data with the second demographic data to identify the payment made by the first payer to the service provider as a possible underpayment, determining that the payment is less than an amount allowable by a second payer for the service provided, and generating a payment request for the difference between the allowable amount and the payment.

8. The computer system of claim 7 wherein the first payer is Medicare, and the data warehouse is a HIPAA Eligibility Transaction System database.

9. The computer system of claim 7 wherein the first payer is Medicaid, and the data warehouse is a state Medicaid database.

10. The computer system of claim 7 wherein the second payer has made no remittance for the service provided to the consumer and the payment request is a request for the difference to be paid by the second payer, and further comprising sending the payment request to the second payer.

11. The computer system of claim 7 wherein the second payer has paid the allowable amount to the first payer for the service provided to the consumer and the payment request is a request for the difference to be paid by the first payer, and further comprising sending the payment request to the first payer.

12. The computer system of claim 7 wherein the service provided is a health care service and the consumer is a patient.

13. A computer program product comprising:
a computer-readable storage medium; and
program instructions residing in said storage medium for managing coordination of benefits for a service provided to a consumer by receiving claim data from a service provider wherein the claim data includes service data associated with the service provided to the consumer and first demographic data associated with the consumer, receiving benefits data from a data warehouse of a first payer wherein the benefits data includes second demographic data and payment information including a payment made by the first payer to the service provider for the service provided, correlating the first demographic data with the second demographic data to identify the payment made by the first payer to the service provider as a possible underpayment, determining that the payment is less than an amount allowable by a second payer for the service provided, and generating a payment request for the difference between the allowable amount and the payment.

14. The computer program product of claim 14 wherein the first payer is Medicare, and the data warehouse is a HIPAA Eligibility Transaction System database.

15. The computer program product of claim 14 wherein the first payer is Medicaid, and the data warehouse is a state Medicaid database.

16. The computer program product of claim 14 wherein the second payer has made no remittance for the service provided to the consumer and the payment request is a request for the difference to be paid by the second payer, and further comprising sending the payment request to the second payer.

17. The computer program product of claim 14 wherein the second payer has paid the allowable amount to the first payer for the service provided to the consumer and the payment request is a request for the difference to be paid by the first payer, and further comprising sending the payment request to the first payer.

18. The computer program product of claim 14 wherein the service provided is a health care service and the consumer is a patient.

19. A method of managing coordination of benefits for a health care service provided to a patient comprising:
receiving claim data from a health care service provider wherein the claim data includes service data associated with the service provided to the patient and first demographic data associated with the patient, the first demographic data including at least two of a first patient name, a first patient social security number, and a first patient date of birth;
receiving benefits data from a data warehouse of a first payer wherein the benefits data includes second demographic data and payment information including a payment made by the first payer to the service provider for the service provided, the second demographic data including at least two of a second patient name, a second patient social security number, and a second patient date of birth;
correlating the first demographic data with the second demographic data by matching at least two of the first patient name, the first patient social security number, and the first patient date of birth with at least two of second patient name, the second patient social security number, and the second patient date of birth, to identify the payment made by the first payer to the service provider as a possible underpayment;
determining that the payment is less than an amount allowable by a second payer for the service provided, and that the second payer has made no remittance for the service provided to the consumer;
generating a payment request for the difference between the allowable amount and the payment to be paid by the second payer; and
sending the payment request to the second payer.
